(19) United States
(12) Patent Application Publication
(10) Pub. No.: US 2026/0006374 A1
(43) Pub. Date: Jan. 1, 2026

(54) ACOUSTIC APPARATUS

(71) Applicant: ALPS ALPINE CO., LTD., Tokyo (JP)

(72) Inventors: Ryo ITO, Fukushima (JP); Hiroyuki TAGUCHI, Fukushima (JP)

(21) Appl. No.: 19/230,370

(22) Filed: Jun. 6, 2025

(30) Foreign Application Priority Data
Jul. 1, 2024 (JP) 2024-106149

(51) Int. Cl. H04R 1/22; H04R 1/02

(52) U.S. Cl. CPC H04R 1/22; H04R 1/025; H04R 2499/13

(57) ABSTRACT

An acoustic apparatus includes an enclosure installed in a seat, and a speaker unit provided inside the enclosure, wherein an internal space of the enclosure is partitioned into a listener-side space and a back space by a diaphragm provided in the speaker unit, a listener-side duct leading to the listener-side space and a back duct leading to the back space are connected to the enclosure, and a listening position is set at a position where a straight-line distance from an opening of the listener-side duct is shorter than a straight-line distance from an opening of the back duct.

### CROSS-REFERENCE TO RELATED APPLICATION

The present application is based on and claims priority to Japanese patent application No. 2024-106149 filed on Jul. 1, 2024, with the Japan Patent Office, the entire contents of which are hereby incorporated by reference.

### BACKGROUND OF THE INVENTION

### 1. Field of the Invention

The disclosures herein relate to acoustic apparatuses that can transmit a sound pressure in which a bass range is enhanced to a listener seated in a seat installed in a vehicle's interior and the like.

### 2. Description of the Related Art

Patent Literature (PTL) 1 describes a speaker system for a moving body. In the speaker system shown in FIG. 3, an enclosure containing a speaker unit is installed on both sides of a vehicle body in a width direction. An opening of the enclosure is covered with a diaphragm of the speaker unit. An acoustic tube is connected to the enclosure. The acoustic tube consists of a first tube member, which is a pillar constituting the vehicle body, and a second tube member with one end connected to the pillar. The second tube member is opened near a floor of the vehicle body.

Paragraphs [0056] and [0057] of PTL 1 explain that the sound emitted from the diaphragm of each speaker unit is radiated directly into the vehicle's interior, and that the bass range component corresponding to a length of the acoustic tube resonates in the acoustic tube, and the sound wave mainly composed of the bass range component is radiated into the vehicle's interior.

In the speaker system for the moving body described in PTL 1, since a Helmholtz resonator includes the enclosure and the acoustic tube, near a resonance frequency of the Helmholtz resonator, an amplitude of the diaphragm is reduced due to the resonance of air in the acoustic tube. In the speaker system for the moving body, the acoustic wave is directly applied from the diaphragm to an ear of the listener. Therefore, an output of the sound that reaches the ear of the listener from the diaphragm is lowered near the resonance frequency of the Helmholtz resonator. In addition, since the amplitude of the diaphragm decreases even in a frequency band lower than the resonance frequency of the Helmholtz resonator, it is difficult to deliver bass sound waves from the diaphragm to the ear of the listener with sufficient sensitivity in a wide frequency band.

PTL 1 describes that bass range components resonate in the acoustic tube, and sound waves mainly composed of bass range components are emitted into the vehicle's interior. However, in the frequency band lower than the resonance frequency of the Helmholtz resonator, phases of the sound waves emitted from the diaphragm of the speaker unit and from the opening of the acoustic tube are inverted (the phases differ by 180 degrees), resulting in mutual cancellation of amplitudes and reducing bass range sound efficiency.

Conversely, for example, when the listener sitting on a left seat in the vehicle body listens to sound waves from the diaphragm of the left speaker unit, the sound waves from the right diaphragm and the sound waves from the opening of the right acoustic tube located far away from the diaphragm cancel each other in the frequency band lower than the resonance frequency of the Helmholtz resonator. Therefore, it becomes difficult for the listener sitting on the left seat to hear the bass sound from the right speaker unit. By utilizing this effect, it is possible to construct a system in which the listener sitting on each seat listens to individualized sound. However, as described in FIG. 3 of PTL 1, if a tube part of the acoustic tube is too long, it requires a long time for the sound waves coming from the diaphragm to reach the opening of the acoustic tube. Therefore, the phases of the sound waves coming directly from the diaphragm and the sound waves coming from the opening of the acoustic tube are not completely inverted relative to each other, and therefore, the sound waves coming from the diaphragm and the accompanying sound waves coming from the opening of the acoustic tube do not completely cancel each other. This leads to an issue where bass sound tends to reach an ear of a listener at a distant position.

An object of the present disclosure is to solve the above-mentioned problems, and to provide an acoustic apparatus in which a listener sitting on a seat in a vehicle or the like can listen to a relatively wide range of bass sounds with a sufficiently large sound pressure.

Also, an object of the present disclosure is to provide an acoustic apparatus that effectively attenuates bass sound pressure for listeners at distant positions, and while being suitably configured to allow each listener in each seat to experience individualized sound.

### CITATION LIST

### Patent Literature

[PTL 1] Domestic Re-publication of PCT International Application WO 2017/038443

### SUMMARY OF THE INVENTION

An acoustic apparatus includes an enclosure installed in a seat, and a speaker unit provided inside the enclosure, wherein an internal space of the enclosure is partitioned into a listener-side space and a back space by a diaphragm provided in the speaker unit, a listener-side duct leading to the listener-side space and a back duct leading to the back space are connected to the enclosure, and a listening position is set at a position where a straight-line distance from an opening of the listener-side duct is shorter than a straight-line distance from an opening of the back duct.

In the acoustic apparatus of the present disclosure, it is preferable that a tube length of the back duct extending from the diaphragm to the opening of the back duct is shorter than a tube length of the listener-side duct extending from the diaphragm to the opening of the listener-side duct. For example, it is preferable that a difference between the tube length of the listener-side duct and the tube length of the back duct is 18 cm or less.

In the acoustic apparatus of the present disclosure, it is preferable that a resonance frequency of a back Helmholtz resonator including the back space and the back duct is set in a higher frequency band than a resonance frequency of a listener-side Helmholtz resonator including the listener-side space and the listener-side duct.

In the acoustic apparatus of the present disclosure, for example, an area of the opening of the listener-side duct is smaller than an area of the opening of the back duct, and a tube length of the listener-side duct is longer than a tube length of the back duct.

In the acoustic apparatus of the present disclosure, it is preferable that a resonance frequency of vibrating mass including mass of a vibrating part of the speaker unit, load mass of air in the listener-side duct, and load mass of air in the back duct is set in a frequency band lower than the resonance frequency of the listener-side Helmholtz resonator including the listener-side space and the listener-side duct.

In the acoustic apparatus of the present disclosure, since the listening position is set close to the opening of the listener-side duct, the sound pressure emitted from the opening of the listener-side duct is preferentially delivered to the listener. The listener-side Helmholtz resonator includes the listener-side space and the listener-side duct in the enclosure, and a movement of the diaphragm of the speaker unit is reduced in proximity of the resonance frequency of the Helmholtz resonator, but since air resonates in the listener-side duct, even in the frequency band near the resonance frequency of the Helmholtz resonator, it is possible to deliver bass sound with sufficient sensitivity to the ear of the listener from the opening of the listener-side duct.

In the frequency band lower than the resonance frequency of the Helmholtz resonator, the air inside the listener-side duct and the diaphragm vibrate in the same phase, so that the phase of the sound pressure emitted from the opening of the listener-side duct and the sound pressure applied from the diaphragm to the back space are inverted. Therefore, at the position far from the acoustic apparatus, the sound pressure emitted from the opening of the listener-side duct and the sound applied from the diaphragm to the back space cancel each other, and the bass sound from the acoustic apparatus is hardly leaked to the position away from the acoustic apparatus. Here, in order to generate the bass sound from the listener-side duct, it is preferable to lengthen the listener-side duct to increase the load mass in the listener-side duct, to substantially increase the mass of the vibrating part of the speaker unit, and to make the resonance frequency of the vibrating part as low as possible. In this case, since a propagation path of sound from the diaphragm to the opening of the listener-side duct becomes longer, the sound pressure emitted from the opening of the listener-side duct and the sound pressure applied from the diaphragm to the back space, which are originally opposite in phase, approach toward the same phase. Therefore, in the present disclosure, by providing the back duct extending from the back space and lengthening the propagation path of sound in the back duct as well, the phase difference between the sound emitted from the opening of the listener-side duct and the sound emitted from the opening of the back duct can be brought close to the opposite phase, and the effect of preventing the bass sound from leaking away from the acoustic apparatus can be maintained.

In the present disclosure, not only the air in the listener-side duct is the load mass, but also the air in the back duct is the load mass, and these load masses function to substantially increase the vibrating system mass of the vibrating part including the diaphragm. Therefore, the resonance frequency of the vibrating system mass can be set to a low band, and the bass sound frequency band can be obtained from the listener-side duct. Since the air in the back duct becomes the load mass of the vibrating part, the resonance frequency of the vibrating system mass can be set to the low band without forming the listener-side duct excessively narrow and long, and the resonance frequency of the listener-side Helmholtz resonator can be moved to a relatively high range by setting the listener-side duct to be slightly thick or slightly short. As a result, a phenomenon to reduce the amplitude of the diaphragm, which occurs near the resonance frequency, can be shifted to a relatively high frequency band, and the sound obtained from the listener-side duct can be set to a wide band of bass sound.

### BRIEF DESCRIPTION OF THE DRAWINGS

FIG. 1 is a side view illustrating a state in which an acoustic apparatus according to the present embodiment is attached to a seat in a vehicle;

FIG. 2 is a perspective view of the acoustic apparatus and seat shown in FIG. 1 seen from a front;

FIG. 3 is a vertical cross-sectional view of the acoustic apparatus shown in FIG. 2 cut along a line III-III;

FIG. 4 is a horizontal cross-sectional view of the acoustic apparatus shown in FIG. 2 cut along a line IV-IV;

FIG. 5 is a simplified schematic diagram illustrating a structure of the acoustic apparatus according to the present embodiment;

FIG. 6A is a graph describing an acoustic operation of an acoustic apparatus of a general structure having an enclosure and a duct as a comparative example; and

FIG. 6B is a graph describing an acoustic operation of the acoustic apparatus of the present embodiment.

### DESCRIPTION OF THE PREFERRED EMBODIMENTS

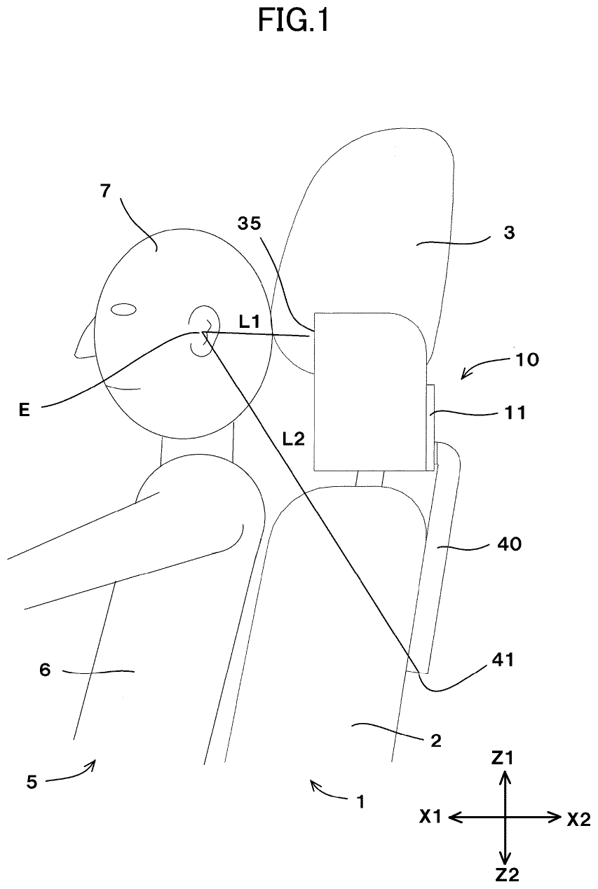

FIGS. 1 to 4 illustrate an acoustic apparatus 10 of the present embodiment.

In FIGS. 1 to 4, an X1-X2 direction is a front-rear direction, an X1-direction is a front direction, that is, a direction in which a vehicle travels, and an X2-direction is a rear direction. A Z1-Z2 direction is an upper-lower direction, a Z1-direction is an upper direction, and a Z2-direction is a lower direction. A Y1-Y2 direction is a left-right direction, a Y1-direction is a left direction, and a Y2-direction is a right direction.

An acoustic apparatus 10 is installed between a seat back 2 of a seat 1 of an automobile and a headrest 3. FIG. 1 shows a listener 5 seated on the seat 1. The listener 5 is a driver, and a head 7 of the listener 5 is located forward the headrest 3. Listening positions of the acoustic apparatus 10 are set to positions of left and right ears E of the head 7, and openings 34, 35 of the listener-side duct are located in proximity of the listening positions. The acoustic apparatus 10 may be installed inside a seat back or a headrest so long as the openings 34, 35 are located in proximity of the listening positions. The seat 1 in which the acoustic apparatus 10 is installed may be a seat of transportation other than an automobile, for example a train. Moreover, the seat may be installed in theaters or video game arcades, and may also be for household use.

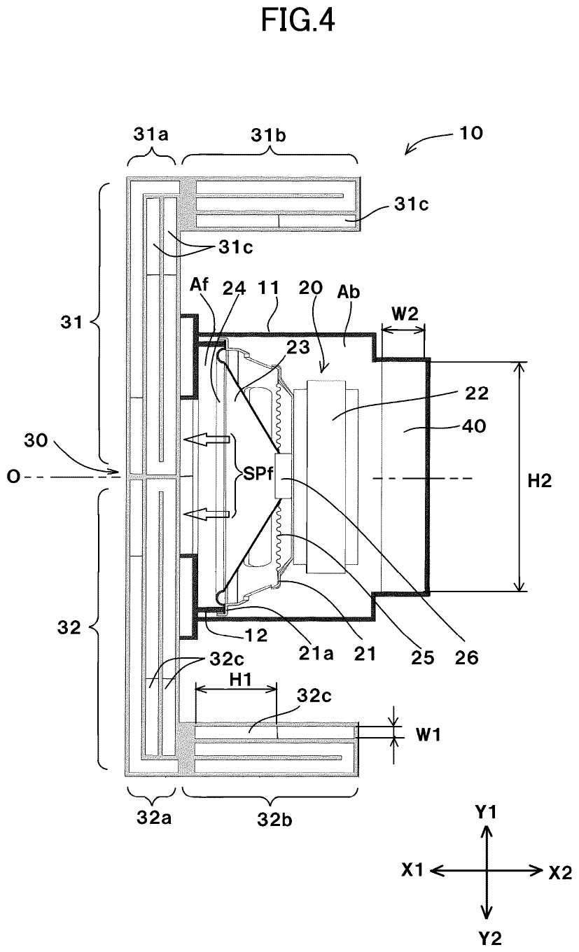

As shown in a cross sectional view of FIG. 4, the acoustic apparatus 10 has an enclosure 11, and a speaker unit 20 is housed in the enclosure 11. The speaker unit 20 has a frame 21. A front periphery 21a of the frame 21 is fixed to a support 12 inside the enclosure 11. A magnetic circuit 22 is fixed to a rear of the frame 21. The magnetic circuit 22 includes a magnet and a yoke made of a magnetic material, and forms a magnetic gap, which is a cylindrical gap. A diaphragm 23 is supported by the frame 21. The diaphragm 23 has a conical shape, the front periphery is supported by the frame 21 via an edge member 24, and the rear portion is supported by the frame 21 via a damper 25. The edge member 24 and the damper 25 are elastically deformable, and the diaphragm 23 is supported in the front-rear direction (X1-X2 direction) by the elastic deformation of the edge member 24 and the damper 25, enabling free vibration. A cylindrical bobbin 26 is fixed to a rear end of the diaphragm 23. A voice coil is wound around the rear part of the bobbin 26, and the voice coil is inserted into the magnetic gap of the magnetic circuit 22. The diaphragm 23 is vibrated in the front-rear direction by electromagnetic force caused by a magnetic field crossing the voice coil in the magnetic circuit 22 and a voice current flowing through the voice coil.

The opening facing a front of the cylindrical bobbin 26 is closed by a cap member. An internal space of the enclosure 11 is partitioned in the front-rear direction by the diaphragm 23 and the cap member, and is partitioned into a front listener-side space Af and a rear back space Ab. As shown in FIG. 4, a listener-side duct 30 communicating with the listener-side space Af is connected to the front of the enclosure 11, and a back duct 40 communicating with the back space Ab is connected to the rear of the enclosure 11.

FIG. 4 shows a vibration center line O extending in the vibration direction of the diaphragm 23. When viewed in a planar cross-sectional view of FIG. 4, the listener-side duct 30 includes a left duct 31 composed of a left (Y1 direction) half and a right duct 32 composed of a right (Y2 direction) half with the vibration center line O as a boundary. The left duct 31 and the right duct 32 have a structure with line symmetry in the left-right direction (Y1-Y2 direction) with respect to the vibration center line O. A forward sound pressure SPf applied to the listener-side space Af by the vibration of the diaphragm 23 is input to both the left duct 31 and the right duct 32. The left duct 31 has a front tube 31a extending in the left direction (Y1 direction) and a side tube 31b extending in the rear direction (X2 direction). The right duct 32 also has a front tube 32a extending in the right direction (Y2 direction) and a side tube 32b extending in the rear direction (X2 direction).

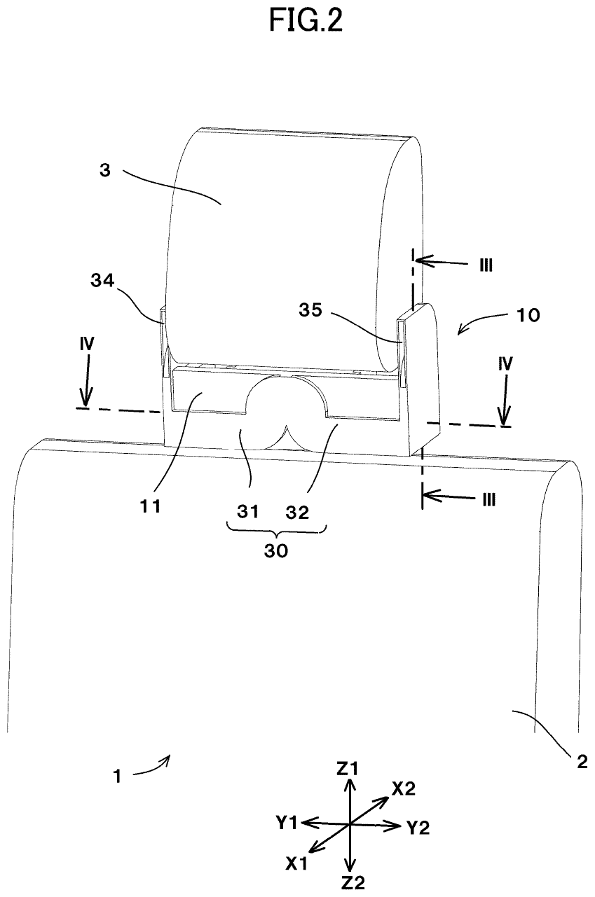

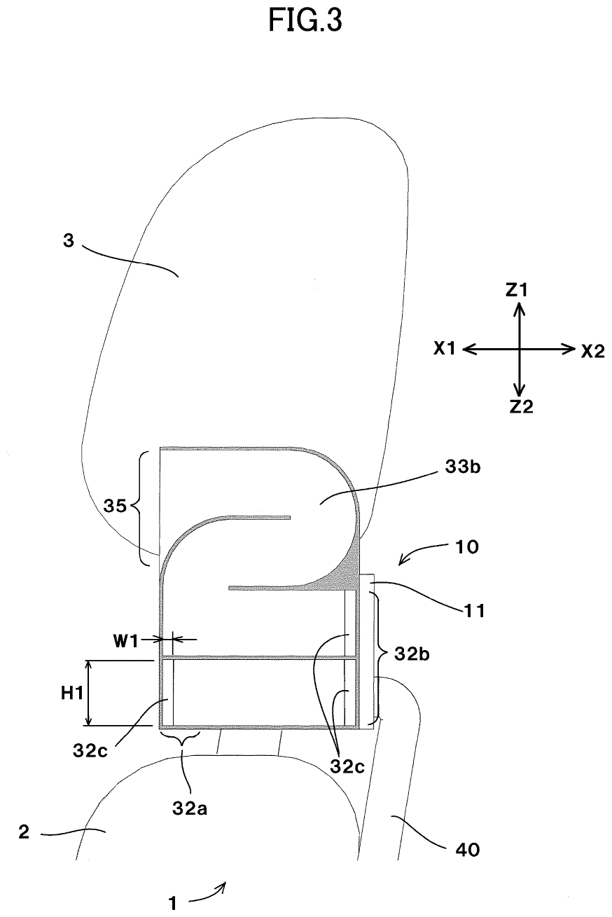

As shown in FIG. 3, the front tube 32a and the side tube 32b of the right duct 32 are stacked in two stages in the vertical direction (Z1-Z2 direction), and the tube part formed in a labyrinth shape in the upper stage and the tube part formed in a labyrinth shape in the lower stage are connected through a plurality of communication parts 32c. The tube part of the front tube 32a and the tube part of the side tube 32b are also connected through a plurality of communication parts 32c. The internal cross section of the tube is rectangular at each point, and the internal cross section has a uniform shape with the long side being H1 and the short side being W1. As shown in FIG. 3, in the right duct 32, an extension tube 33b continues to the upper part of the two stages of the side tube 32b, and the end of the extension tube 33b is the opening 35. As shown in FIG. 2, the opening 35 is opened toward the front (X1 direction). In the left duct 31, the two stages of the front tube 31a and the side tube 31b are connected through a plurality of communication parts 31c, and the tube part of the front tube 31a and the tube part of the side tube 31b are connected through a plurality of communication parts 31c. The tube part constituting the left duct 31 also has a rectangular internal cross section. In the left duct 31, an extension tube continues to the upper part of the two upper and lower side tubes 31b, and as shown in FIG. 2, the end of the extension tube forms the opening 34, which is opened toward the front (X1 direction).

In the left duct 31, the forward sound pressure SPf input from the listener-side space Af to the front tube 31a passes through one tube path consisting of a rectangular tube with a uniform cross section, and is emitted toward the front (X1 direction) from the opening 35. In the right duct 32, the forward sound pressure SPf input from the listener-side space Af to the front tube 32a passes through one tube path consisting of a rectangular tube with a uniform cross section, and is emitted toward the front (X1 direction) from the opening 35.

As shown in FIG. 4, the back duct 40 communicates with the back space Ab in the enclosure 11. As shown in FIG. 1, the back duct 40 extends downward along the rear surface of the seat back 2, and the opening 41 of the back duct 40 is directed downward (Z2 direction). As shown in FIG. 4, the internal cross section of the back duct 40 is rectangular, and the long side is H2 and the short side is W2. A cross-sectional area of the back duct 40 is uniform over the entire length.

As shown in FIG. 1, in the acoustic apparatus 10, the position of the ears E is set as the listening position when a standard-type adult listener 5 is seated on the seat 1 and the head 7 is in contact with the headrest 4. The positions of the openings 34, 35 and the opening 41 are determined such that the straight-line distance L1 from the openings 34, 35 of the listener-side duct 30 to the listening position (the position of the ears E) is sufficiently shorter than the straight-line distance L2 from the opening 41 of the back duct 40. In order to enable the listener to preferentially listen to the sound emitted from the openings 34, 35 of the listener-side duct 30, the straight-line distance L1 is preferably a half or less of the straight-line distance L2, and more preferably a third or less of the straight-line distance L2.

Next, an operation of the acoustic apparatus 10 will be described.

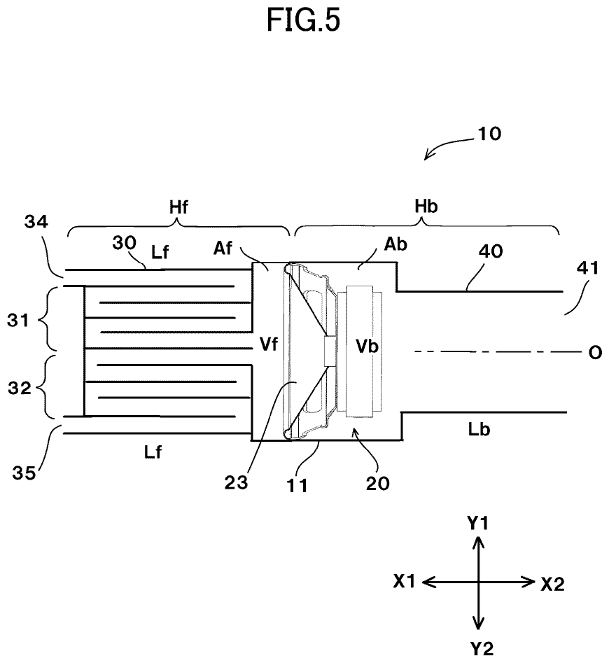

FIG. 5 is a simplified schematic diagram illustrating a structure of the acoustic apparatus 10 according to the present embodiment to describe the structure of the acoustic apparatus 10. In the acoustic apparatus 10, the listener-side Helmholtz resonator Hf is composed of the listener-side space Af in the enclosure 11 and the listener-side duct 30, and the back Helmholtz resonator Hb is composed of the back space Ab in the enclosure 11 and the back duct 40.

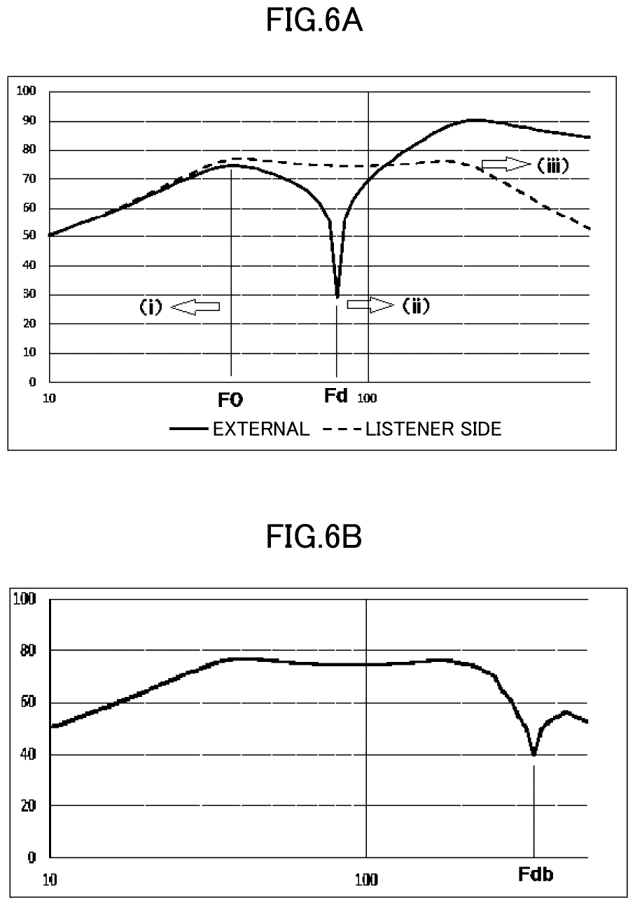

Before describing the acoustic effect of the acoustic apparatus 10 according to the embodiment of the present disclosure, the acoustic effect of the acoustic apparatus of the comparative example will be described based on FIG. 6A.

The comparative example is an acoustic apparatus assumed to lack the back duct 40, where the back sound pressure is directly applied from the diaphragm 23 to the external space in the rear (X2 direction). In other words, this acoustic apparatus is assumed to have no back Helmholtz resonator Hb, and rather is assumed to have only the listener-side Helmholtz resonator Hf. A solid line in FIG. 6A shows the frequency characteristics of the rear sound pressure applied from the diaphragm 23 to the rear external space in the comparative example, and a broken line shows the frequency characteristics of the listener sound pressure observed at the openings 34, 35 of the listener-side duct 30. The acoustic apparatus is used as a subwoofer, and the frequency band used is in the bass range of about 150 Hz or less, and is mainly used in the frequency band lower than the resonance frequency Fd of the listener-side Helmholtz resonator Hf. In the frequency band lower than the resonance frequency Fd of the listener-side Helmholtz resonator Hf, the air in the diaphragm 23 and the listener-side duct 30 move in the same phase, so that the listener sound pressure observed at the openings 34, 35 of the listener-side duct 30 and the rear sound pressure applied to the rear external space from the diaphragm 23 differ in phase by 180 degrees and are in opposite phase.

The acoustic apparatus assumed in the comparative example is similar to the acoustic apparatus 10 of the embodiment of the present disclosure, the openings 34, 35 of the listener-side duct 30 are arranged near the ear E of the listener 5 who is sitting on the seat 1, and the output part of the back sound pressure applied to the rear external space from the diaphragm 23 is kept away from the ear E of the listener 5. Therefore, the listener 5 is less affected by the sound pressure of the opposite phase which is applied to the rear external space from the diaphragm 23, and can preferentially listen to the sound emitted from the listener-side duct 30. Conversely, at a position far from the acoustic apparatus, the listener sound pressure from the openings 34, 35 of the listener-side duct 30 and the back sound pressure applied to the rear external space from the diaphragm 23 reach, so that the listener sound pressure and the back sound pressure which are in opposite phase interfere with each other, and the bass sound in the frequency band lower than the resonance frequency Fd of the listener-side Helmholtz resonator Hf is weakened at a position away from the acoustic apparatus. Therefore, the acoustic apparatus is suitable for use as a system for listening to different sound sources at individual seats.

In order to increase the output of the frequency band lower than a resonance frequency Fd of the listener-side Helmholtz resonator Hf in the acoustic apparatus, it is effective to increase the air load mass (air load) in the listener-side duct 30, substantially increase the vibration system mass including the diaphragm 23, and decrease a resonance frequency of the vibration section. In order to increase the load mass of air in the listener-side duct 30, it is necessary to narrow or lengthen the listener-side duct 30. However, if the listener-side duct 30 is too narrow, airflow noise is likely to occur in the duct. Therefore, it is effective to lengthen the tube length of the listener-side duct 30 in order to reduce the resonance frequency of the vibrating part. However, if the tube length is lengthened, it takes time for the listening sound pressure emitted forward by the vibration of the diaphragm 23 to reach the openings 34, 35 of the listener-side duct 30. As a result, the phases of the listening sound pressure emitted from the openings 34, 35 and the back sound pressure of the opposite phase emitted backward from the diaphragm 23 become close to each other, and interference between the listening sound pressure and the back sound pressure at the position away from the acoustic apparatus 10 becomes weak, so that the bass sound in the frequency band lower than the resonance frequency Fd of the listener-side Helmholtz resonator Hf tend to reach the position away from the acoustic apparatus 10, and the bass sound from the remote speaker system becomes intrusive when listeners in individual seats experience personalized sound sources.

The acoustic apparatus 10 according to the embodiment of the present disclosure can solve the above problems related to the characteristics of the acoustic apparatus described in the comparative example.

The acoustic apparatus 10 is provided with a back duct 40 connecting to the back space Ab in the enclosure 11, and the back sound pressure applied from the diaphragm 23 to the back space Ab is discharged from the opening 41 to the external space at the back of the seat 1 via the back duct 40. Since it requires time for the back sound pressure generated from the diaphragm 23 to reach the opening 41 of the back duct 40, the phase difference between the listening sound pressure emitted from the openings 34, 35 of the listener-side duct 30 and the back sound pressure emitted from the opening 41 of the back duct 40 can be made close to the opposite phase, that is, 180 degrees. Therefore, at a position away from the acoustic apparatus 10, the listening sound pressure and the back sound pressure tend to cancel each other at a frequency band lower than the resonance frequency Fd of the listener-side Helmholtz resonator Hf, and when a listener in an individual seat experiences a personalized sound source, an intrusive bass sound from a remote speaker system can be prevented.

In order to obtain the effect that the listening sound pressure emitted from the openings 34, 35 of the listener-side duct 30 and the back sound pressure emitted from the opening 41 of the back duct 40 weaken each other due to interference when listening at a position away from the acoustic apparatus 10, it is preferable that the phase difference between the listening sound pressure and the back sound pressure stay within 30 degrees from 180 degrees, which is optimal for cancellation. For this purpose, it is preferable that the difference (Lf−Lb) between the tube length Lf of the left duct 31 and the right duct 32 of the listener-side duct 30 and the tube length Lb of the back duct 40 is less than a twelfth of the used wavelength. When the upper limit of the bass sound frequency reproduced as a subwoofer is set to 150 Hz, the difference (Lf−Lb) between the tube lengths is preferably set to 18 cm or less. When the upper limit of the reproduced bass sound frequency is set to 120 Hz, the difference between the tube lengths is preferably set to 23 cm or less. In addition, when the difference in the tube lengths is set to 28 cm or less, in a band where the reproduced bass sound frequency is 100 Hz or less, the effect of weakening each other by interference between the listening sound pressure emitted from the openings 34, 35 of the listener-side duct 30 and the back sound pressure emitted from the opening 41 of the back duct 40 can be increased.

As shown in the schematic diagram of FIG. 5, since the acoustic apparatus 10 of the embodiment is provided with the back duct 40, not only the air in the listener-side duct 30 but also the air in the back duct 40 acts as the load mass when the diaphragm 23 vibrates. Since the vibrating system mass including the diaphragm 23 increases by providing the listener-side duct 30, the resonance frequency F0 of the vibrating system mass including the diaphragm 23 can be moved to a lower band as indicated by an arrow (i) compared with the acoustic characteristic of the comparative example of FIG. 6A.

Since the air in the back duct 40 is added to the vibrating system mass of the acoustic apparatus 10, the resonance frequency of the vibrating system mass can be lowered without making the tube length of the listener-side duct 30 extremely long. Since it is not necessary to make the tube length of the listener-side duct 30 extremely long, the resonance frequency Fd of the listener-side Helmholtz resonator Hf can be moved to a higher frequency range as indicated by an arrow (ii) than in the comparative example of FIG. 6A. Incidentally, the resonance frequency Fd of the Helmholtz resonator without considering the operation of the vibrating part of the speaker unit 20 is physically calculated by an internal volume (V) of the enclosure, the length (L) of the duct, and the cross-sectional area (S), and is obtained by an equation: Fd=(C/2·π) √(S/V·L); (C is the speed of sound). The resonance frequency Fd is inversely proportional to the internal volume (V) of the enclosure and the length (L) of the duct, and proportional to the cross-sectional area (S) of the duct.

As shown by the solid line in FIG. 6A, near the resonance frequency Fd of the listener-side Helmholtz resonator Hf, the amplitude of the diaphragm is reduced by the internal pressure of the enclosure due to the resonance of the air in the listener-side duct 30, and the sound pressure from the diaphragm is lowered. However, since the air in the listener-side duct 30 resonates, as shown by the broken line, relatively large sound pressure can be generated from the openings 34, 35 of the listener-side duct 30 in the frequency band including the resonance frequency F0 of the vibrating part and the resonance frequency Fd of the listener-side Helmholtz resonator Hf. In the acoustic apparatus 10 of the embodiment of the present disclosure, the resonance frequency F0 of the vibrating part including the diaphragm 23 can be moved to a lower band as indicated by an arrow (i) in FIG. 6A by the load mass of the air in the back duct 40, and since the load mass of the vibrating part can be increased without making the listener-side duct 30 extremely long, the resonance frequency Fd of the listener-side Helmholtz resonator Hf can be moved to a higher frequency band as indicated by an arrow (ii) in FIG. 6A. Therefore, as indicated by an arrow (iii) in FIG. 6A, an audible sound pressure can be applied from the openings 34, 35 of the listener-side duct 30 to the ear E of the listener 5 in a wide frequency band.

As shown in the schematic diagram of FIG. 5, in the acoustic apparatus 10 of the embodiment of the present disclosure, the resonance frequency of the listener-side Helmholtz resonator Hf is calculated by using the internal volume Vf of the listener-side space Af and the length of two ducts, namely, the tube length Lf of the ducts on the left duct 31 and the tube length Lf of the ducts on the right duct 32, as parameters, and the resonance frequency of the back Helmholtz resonator Hb is calculated by using the internal volume Vb of the back space Ab and the tube length Lb of the ducts on the back duct 40 as parameters. In the acoustic apparatus 10 of the present disclosure, for example, it is preferable to set the resonance frequency of the back Helmholtz resonator Hb in a higher frequency band than the resonance frequency of the listener-side Helmholtz resonator Hf by making the tube length Lb of the ducts on the back duct 40 shorter than the tube length Lf of the ducts on the listener-side duct 30 and/or by making the inner cross-sectional area of the ducts 40 wider than the inner cross-sectional area of the listener-side duct 30.

FIG. 6B shows the frequency characteristics of the sound pressure obtained from the diaphragm 23 when only the back Helmholtz resonator Hb is focused, assuming that there is no listener-side Helmholtz resonator Hf. As shown in FIG. 6B, the movement of the diaphragm 23 is reduced by the resonance of vibration in the back duct 40 near the resonance frequency Fdb of the back Helmholtz resonator Hb. By setting the resonance frequency Fdb of the back Helmholtz resonator Hb to a higher band than the resonance frequency of the listener-side Helmholtz resonator Hf, the region where the movement of the diaphragm 23 is reduced can be moved to a higher frequency band, and the phenomenon that the movement of the diaphragm 23 caused by the back Helmholtz resonator Hb is restricted within the frequency band used as a subwoofer can be prevented.

What is claimed is:

1. An acoustic apparatus, comprising:
an enclosure installed in a seat; and
a speaker unit provided inside the enclosure,
wherein:
an internal space of the enclosure is partitioned into a listener-side space and a back space by a diaphragm provided in the speaker unit;
a listener-side duct communicating with the listener-side space and a back duct communicating with the back space are connected to the enclosure; and
a listening position is set at a position where a straight-line distance from an opening of the listener-side duct is shorter than a straight-line distance from an opening of the back duct.

2. The acoustic apparatus according to claim 1, wherein a tube length of the back duct extending from the diaphragm to the opening of the back duct is shorter than a tube length of the listener-side duct extending from the diaphragm to the opening of the listener-side duct.

3. The acoustic apparatus according to claim 2, wherein a difference between the tube length of the listener-side duct and the tube length of the back duct is 18 cm or less.

4. The acoustic apparatus according to claim 1, wherein a resonance frequency of a back Helmholtz resonator including the back space and the back duct is set in a higher frequency band than a resonance frequency of a listener-side Helmholtz resonator including the listener-side space and the listener-side duct.

5. The acoustic apparatus according to claim 4, wherein an area of the opening of the listener-side duct is smaller than an area of the opening of the back duct, and a tube length of the listener-side duct is longer than a tube length of the back duct.

6. The acoustic apparatus according to claim 4, wherein a resonance frequency of vibrating mass including mass of a vibrating part of the speaker unit, load mass of air in the listener-side duct, and load mass of air in the back duct is set in a frequency band lower than the resonance frequency of the listener-side Helmholtz resonator including the listener-side space and the listener-side duct.
